(19) United States
(12) Patent Application Publication
(10) Pub. No.: US 2019/0390764 A1
(43) Pub. Date: Dec. 26, 2019

(54) METHOD AND CONTROL UNIT FOR BRAKING A VEHICLE AND SWITCH DEVICE FOR A VEHICLE

(71) Applicant: ZF Friedrichshafen AG, Friedrichshafen (DE)

(72) Inventors: Bernd Geiselhardt, Friedrichshafen (DE); Walter Hecht, Ravensburg (DE); Ludger Rake, Steinfeld (DE); Franz-Josef Schuler, Kressbronn (DE)

(73) Assignee: ZF Friedrichshafen AG, Friedrichshafen (DE)

(21) Appl. No.: 16/484,009

(22) PCT Filed: Jan. 2, 2018
(86) PCT No.: PCT/EP2018/050026

§ 371 Date: Aug. 6, 2019

(30) Foreign Application Priority Data
Feb. 6, 2017 (DE) 10 2017 201 844.5

(51) Int. Cl. F16H 59/54; F16H 59/10; F16H 63/34; B60W 40/105; B60W 20/30

(52) U.S. Cl. CPC F16H 59/54; F16H 59/105; B60W 20/30; B60W 40/105; F16H 63/3416

(57) ABSTRACT

A method may include at least a step for inputting a parking position signal and a step for issuing a braking signal. In the step for inputting a parking position signal, at least one parking position signal is input that represents a movement of a gearshift lever of an automatic shifting device in the vehicle toward a gearshift lever parking position (P) by a driver of the vehicle via at least one intermediate position (Z). In the step for issuing a braking signal, at least one braking signal is issued for executing a braking procedure to reduce the speed of the vehicle using the parking position signal when the speed of the vehicle exceeds a predetermined minimum speed.

### RELATED APPLICATIONS

This application is a filing under 35 U.S.C. § 371 of International Patent Application PCT/EP2018/050026, filed Jan. 2, 2018, and claiming priority to German Patent Application 10 2017 201 844.5, filed Feb. 6, 2017. All applications listed in this paragraph are hereby incorporated by reference in their entireties.

### TECHNICAL FIELD

The embodiments of the present disclosure relate to a method and a control unit for braking a vehicle, and a shifting device for a vehicle.

### BACKGROUND

Shifting devices for controlling automatic transmissions in vehicles normally have the positions P, R, N, and D. Gearshift levers are known for setting the positions, that have an additional gearshift lever position B. When this gearshift lever position B is selected, the vehicle is braked.

Based on this background, the present invention results in an improved method for and an improved control unit for braking a vehicle, as well as an improved shifting device for a vehicle.

### BRIEF DESCRIPTION OF THE DRAWINGS

FIG. 1 shows a schematic illustration of the shifting device, that has a control unit for braking a vehicle according to an exemplary embodiment.

FIG. 2 shows a schematic illustration of a shifting pattern for a gearshift lever in a gearshift lever unit of a shifting device according to an exemplary embodiment.

FIG. 3 shows a schematic illustration of a shifting pattern for a gearshift lever in a gearshift lever unit of a shifting device according to an exemplary embodiment.

FIG. 4 shows a schematic illustration of a shifting pattern for a gearshift lever in a gearshift lever unit of a shifting device according to an exemplary embodiment.

FIG. 5 shows a method for braking a vehicle according to an exemplary embodiment.

### DETAILED DESCRIPTION

A braking of a vehicle and the engagement of a transmission parking position in an automatic transmission of the vehicle is advantageously enabled, by moving a gearshift lever of a shifting device to, or in at least the direction of, a single gearshift lever parking position, by the invention presented herein.

A method for braking a vehicle comprises at least a step for inputting a parking position signal and a step for issuing a braking signal. In the step for inputting a parking position signal, at least one parking position signal is input that represents a movement of a gearshift lever in an automatic shifting device of the vehicle by a driver of the vehicle toward a gearshift lever parking position via at least one intermediate position. In the step for issuing a braking signal, at least one braking signal is issued for executing a braking procedure in order to reduce the speed of the vehicle through the use of the parking position signal, if a speed signal indicates that the speed of the vehicle exceeds a predetermined minimum speed.

The vehicle can be braked with this method when the gearshift lever is moved at least toward the gearshift lever parking position, and the vehicle is still moving too fast to fully engage the transmission parking position. As soon as the predetermined minimum speed of the vehicle has been reached after the braking procedure, or the vehicle is moving slower than the minimum speed, the transmission parking position can then be engaged. The minimum speed can represent a speed of 10 km/h to 1 km/h. Advantageously, both a braking as well as a parking of the vehicle, i.e. an engagement of a transmission parking position in a transmission in the vehicle, can be obtained through a single movement of the gearshift lever that is intuitive for the driver, and can be easily executed.

If the method also comprises a step for generating a resistance acting on the gearshift lever, if the gearshift lever is moved into the at least one intermediate position and/or toward the gearshift lever parking position, and this resistance can generate a haptic feedback for the driver when moving the gearshift lever. This feedback can be used, for example, to inform the driver regarding the force of the braking procedure such that it can be felt. The braking signal can be engineered, for example, to increase the force of the braking procedure based on a length of a path traveled by the gearshift lever through the intermediate position to the gearshift lever parking position. Accordingly, the resistance to movement toward the intended gearshift lever parking position can also be increased. The resistance can also be dependent on a speed of the vehicle, in order to prevent a too strong braking of the vehicle.

According to one embodiment, the method presented herein can advantageously comprise a step for determining a force, in which the force with which the gearshift lever is moved by the driver to the intermediate position and/or the gearshift lever parking position is determined. In the step for issuing the braking signal, the braking signal can then be issued, which can be configured to define a force of the braking procedure based on the applied force. The force of the braking procedure can be increased, for example, in accordance with the increase in the force that is applied.

For a practical implementation of the braking procedure, the method can comprise a step for actuating at least one electronic parking brake in response to the braking signal.

If the method also comprises a step for outputting a vibration signal, which results in a vibration of the gearshift lever and/or another component of the shifting device if the vehicle is moving at a speed of 0 km/h, and the parking brake is not engaged, this can remind the driver of the vehicle to engage the parking brake hapticly.

The method can alternatively or additionally also comprise a step for engaging a parking brake in which a parking brake signal to engage the parking brake is output when the speed signal indicates that vehicle is moving at 0 km/h, within a tolerance range. The tolerance range can comprise, e.g., a speed of less than 1 km/h or less than 5 km/h. As a result, the engagement of the parking brake can also be automated.

It is also advantageous when the method comprises a step for outputting an acoustic signal that is designed to generate an acoustic sound in response to the engagement of the parking brake. This sound can be used to confirm the engagement of the parking brake to the driver acoustically, in order to quickly inform the driver in a simple manner that the vehicle is secured against rolling off. The acoustic signal can be configured to generate a clicking sound, for example.

The method can also comprise a step for receiving an actuation signal that represents an actuation of an actuator by a driver of the vehicle, wherein the step for issuing the braking signal can be executed in response to receiving the actuation signal and the inputting of the parking position signal when the speed signal indicates that the speed of the vehicle exceeds the predetermined minimum speed. As a result, the braking function can first be enabled by the gearshift lever through the actuation of the actuator, in a manner that is clear to the driver.

When the parking position signal is input in the step for inputting the parking position signal, in which the gearshift lever is moved by the driver of the vehicle to at least the intermediate position, and/or toward the gearshift lever parking position, by rotating the gearshift lever designed as a rotational gearshift lever, the method can advantageously be carried out by a shifting device that has a modern rotating gearshift lever.

A control unit for braking a vehicle is configured to execute and/or actuate the steps of the method presented herein in corresponding units, in one of the variations described herein.

The control unit can be an electric device that processes electrical signals, e.g. sensor signals, and outputs control signals on the basis thereof. The control unit can have one or more interfaces, in the form of either hardware or software. A hardware interface can be part of an integrated circuit in which the functions of the control unit are implemented. The interfaces can also be separate integrated circuits, or at least composed in part of discrete components. Software interfaces can be software modules, e.g., on a microcontroller, along with other software modules.

A shifting device for a vehicle contains at least a gearshift lever and the control unit. Such a shifting device can replace known shifting devices, wherein the shifting device presented herein can advantageously execute or implement the method presented above.

A computer program product is also advantageous that contains program code that can be stored on a machine readable medium, such as a semiconductor memory, a hard disk memory, or an optical memory, and is used for executing the method according to any of the embodiments described above when the program is run on a computer or control unit.

In the following description of preferred exemplary embodiments of the present invention, the same or similar reference symbols are used for elements depicted in the various figures that have similar functions, wherein the descriptions of these elements shall not be repeated.

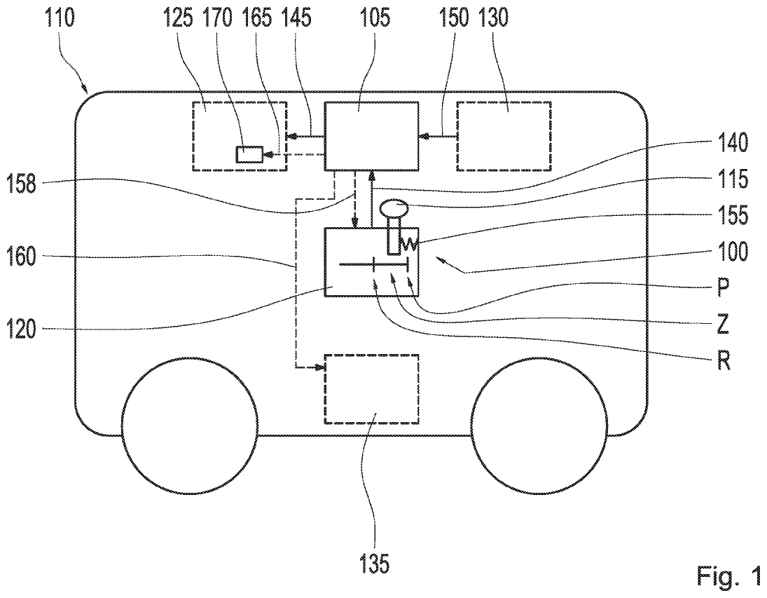

FIG. 1 shows a schematic illustration of a shifting device 100 that has a control unit 105 for braking a vehicle 110 according to an exemplary embodiment. According to this exemplary embodiment, the shifting device 100 is located in the vehicle 110.

The shifting device 100 is in the form of an automatic shifting device 100, and contains at least the control unit 105 and a gearshift lever 115. The gearshift lever 115 is received in a gearshift lever unit 120 according to this exemplary embodiment, and can move in the gearshift lever unit 120 to at least the positions R, Z, P shown in the figure.

Optionally, the shifting device 100 according to this exemplary embodiment also has a braking device 125, a speed detection device 130, and a transmission 135.

The control unit 105 is configured to input a parking position signal 140 that represents a movement of the gearshift lever 115 of the shifting device 100 by a driver of the vehicle 110 toward a gearshift lever parking position P via at least one intermediate position Z. The control unit 105 is configured to use the input parking position signal 140 to issue a braking signal 145 that is configured to initiate a braking procedure to reduce the speed of the vehicle 110 if the speed of the vehicle 110 exceeds a predetermined minimum speed. According to this exemplary embodiment, at least one electronic parking brake is actuated in the braking device 125 with the braking signal 145 in order to brake the vehicle 110.

In order to determine the speed of the vehicle 110, the control unit 105 according to this exemplary embodiment is configured to input a speed signal 150 from the speed detection device 130 in response to the input of the parking position signal 140, wherein the speed signal 150 represent a current speed of the vehicle 110. The speed is then compared with the predetermined minimum speed using the control unit 105.

According to this exemplary embodiment, the gearshift lever unit 120 contains a spring mechanism, e.g. in the form of a spring 155 here, which is configured to generate a resistance on the gearshift lever 115 when the gearshift lever 115, as shown here, is at least located in the intermediate position Z, and/or is moved further toward the gearshift lever parking position P according to an alternative exemplary embodiment. The spring 155 is positioned such that the resistance that the driver feels in the gearshift lever 114 increases as the gearshift lever is moved further toward the gearshift lever parking position P. According to an alternative exemplary embodiment, the gearshift lever unit 120 does not have a spring, and instead has another resistance mechanism, e.g. in the form of an elastic element. The control unit 105 can also be configured to output a resistance signal 158 in response to the parking position signal 140 and the speed signal 150 that generates or adjusts the resistance to the gearshift lever 115 based on the input speed of the vehicle 110.

Optionally, the control unit 105 according to this exemplary embodiment is configured to output a parking signal 160 using the position signal 140, resulting in an engagement of a transmission parking position in the transmission 135 in order to park the vehicle 110 when the speed of the vehicle 110 is at or lower than the predetermined minimum speed.

Optionally, the control unit 105 according to this exemplary embodiment is configured to output a parking brake signal 165 using the position signal 140 that engages a parking brake 170 in the vehicle 110 when the vehicle 110 is moving at a speed of 0 km/h, within a tolerance range.

Details of the shifting device 100 shall be comprehensively described below:

In differing from shifting devices, which can also be referred to as shifting actuators, which only execute a corresponding transmission parking position in an automatic transmission of the vehicle by an actuation of a position P, if this transmission parking position is possible due to the current speed of the vehicle, and which dismiss the intention of the driver at excessive speeds, the shifting device 100 presented herein brakes the vehicle 110, until reaching the predetermined minimum speed, which corresponds to a suitable speed for engaging the transmission parking position of the transmission 135.

The vehicle 110 is braked by the control unit 105 when the gearshift lever parking position P has been selected, and the transmission parking position of the transmission 135 is first engaged when this is allowed by the speed. The electronic parking brake is actuated by the selection of the gearshift lever parking position P according to this exemplary embodiment in order to brake the vehicle 110. The parking brake 170 is also engaged, as a redundant system, when the vehicle is at a standstill, according to this exemplary embodiment.

The control unit 105 presented herein advantageously enables a braking at high speeds without an additional control element, and also increases the comfort for the driver when parking, because there is no shuddering, and increases safety through the so-called force feedback function of the shifting device 100 generated by the resistance.

An advantage of the invention presented herein is a direct feedback to the driver by the resistance that is generated, depicted here in the form of the spring 155, during the braking procedure. The stronger the gearshift lever 115 is pushed toward the gearshift lever parking position P, the more force the driver must use to move the gearshift lever 115 toward the gearshift lever parking position P. The direct feedback to the driver is advantageous. Moreover, this avoids an unpleasant engagement resulting from the braking procedure, and the vehicle does not shudder when the vehicle 110 is braked hard.

According to an alternative exemplary embodiment, the driver is informed of the engagement of the parking brake 170 when the vehicle 110 is close to a standstill by one or more acoustic clicking signals. The driver thus knows that, e.g., the parking brake 170 is engaged, or that the locking brake system in the vehicle 110 is locked. The driver thus receives the direct acoustic feedback, in addition to the feedback from the gearshift lever 115, that the vehicle 110 is secured against rolling off. According to another alternative exemplary embodiment, a vibration signal is output by the control unit 105 that results in a vibration of the gearshift lever if the vehicle 110 is at a standstill but cannot be secured in place, e.g. when no parking brake 170 is detected. The control unit 105, and/or the shifting device 100 presented herein are intended for automatic transmissions, both with and without parking brakes 170.

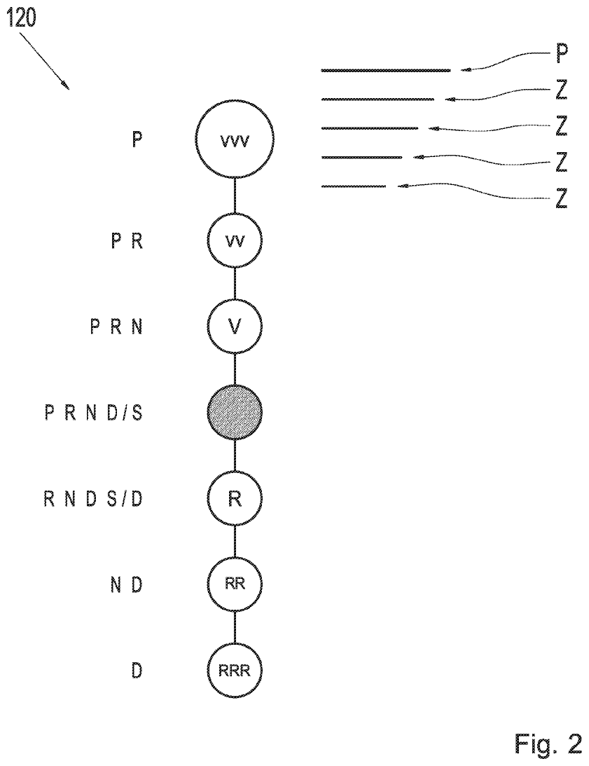

FIG. 2 shows a schematic illustration of a gearshift lever in a gearshift lever unit 120 of a shifting device according to an exemplary embodiment. This can be the shifting device described in reference to FIG. 1.

The gearshift lever can be placed according to this exemplary embodiment in three forward positions V, VV, VVV, and three rear positions R, RR, RRR in the gearshift lever unit 120. The gearshift lever parking position P corresponds to a foremost position VVV in this exemplary embodiment, in which there are four intermediate positions Z between the position VVV and the position VV. The force feedback, thus the resistance, increases according to this exemplary embodiment when the gearshift lever is pushed forward from the position VV toward the position VVV. This corresponds to the braking force in the braking procedure according to this exemplary embodiment.

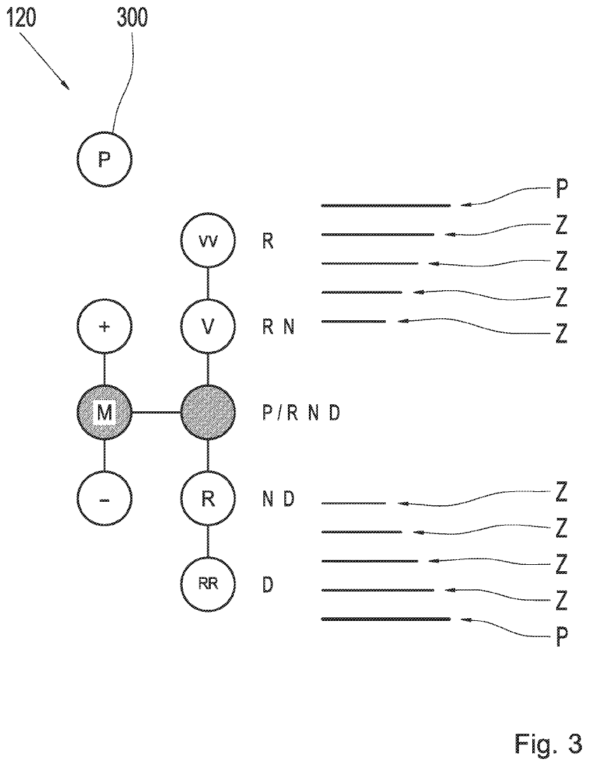

FIG. 3 shows a schematic illustration of a shifting pattern for a gearshift lever in a gearshift unit 120 of a shifting device according to an exemplary embodiment. This can be the gearshift lever unit 120 described in reference to FIG. 2, and the shifting device described in reference to FIG. 1, with the difference that the gearshift lever unit 120 contains an actuator 300.

The gearshift lever according to this exemplary embodiment can only be moved to two forward positions V, VV, and two rear positions R, RR in the gearshift lever unit 120. The gearshift lever parking position P corresponds to a foremost gearshift lever position VV according to this exemplary embodiment, wherein there are four intermediate positions Z located between the position V and the position VV. The force feedback, thus the resistance, increases according to this exemplary embodiment as the gearshift lever is pushed forward from the position V toward the position VV. This corresponds to the braking force in the braking procedure according to this exemplary embodiment. In addition, a further gearshift lever P corresponds to the rearmost position RR in this exemplary embodiment, wherein there are four further intermediate positions Z between the position R and the position RR. The force feedback, thus the resistance, also increases as the gearshift lever is pulled backward from the position R toward the position RR. This corresponds to the braking force in the braking procedure according to this exemplary embodiment.

The actuator 300 is configured to issue an actuation signal for the control unit in response to an actuation by the driver, wherein the braking signal according to this exemplary embodiment is first issued by the control unit in response to receiving the actuation signal and inputting the parking position signal, when the speed of the vehicle exceeds the predetermined minimum speed.

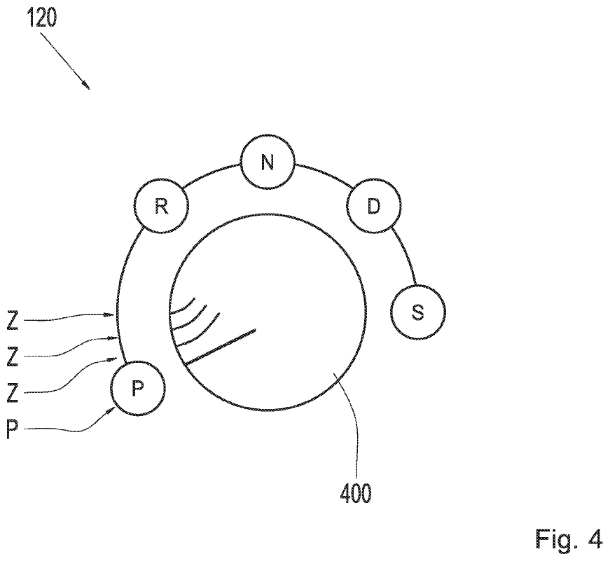

FIG. 4 shows a schematic illustration of a shifting pattern for a gearshift lever in a gearshift lever unit 120 of a shifting device according to an exemplary embodiment. This can be the gearshift lever unit 120 of the shifting device, described in reference to FIG. 1, with the difference that the gearshift lever according to this exemplary embodiment is a circular rotating gearshift lever 400, also referred to as a rotary shifter, which can be rotated to the positions P, Z, Z, Z, R, N, D, S. There are three intermediate positions Z between the gearshift lever position P and a gearshift lever position R. The force feedback is triggered according to this exemplary embodiment by pushing past the gearshift lever parking position P. A braking force of the braking procedure is increased according to this exemplary embodiment by moving the rotary shifter 400 from the gearshift lever position R toward the gearshift lever parking position P via the three positions Z, Z, Z.

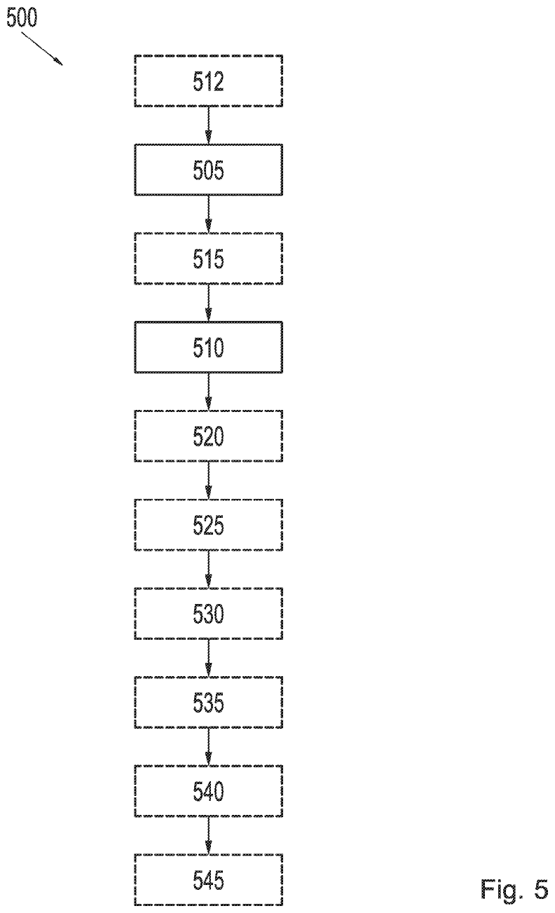

FIG. 5 shows a method 500 for braking a vehicle according to an exemplary embodiment. This can be a method 500 that can be executed by the control unit described in reference to FIG. 1.

The method comprises at least a step 505 for inputting a parking position signal and a step 510 for issuing a braking signal. In the step 505 for inputting a parking position signal, at least one parking position signal is input that represents a movement of a gearshift lever in an automatic shifting device of the vehicle by a driver of the vehicle toward a gearshift lever parking position via at least one intermediate position. In the step 510 for issuing a braking signal, at least one braking signal is issued for executing a braking procedure in order to reduce the speed of vehicle using the parking position signal, if it is indicated by an input speed signal, for example, that the speed of the vehicle exceeds a predetermined minimum speed.

Optionally, the parking position signal is input according to this exemplary embodiment in the step 505 for inputting the parking position signal, in that the movement of the gearshift lever by the driver of the vehicle into at least the intermediate position and/or toward the gearshift lever parking position is carried out by rotating the gearshift lever in the form of a rotary shifter.

Optionally, the method 500 according to this exemplary embodiment also comprises a step 512 for receiving an actuation signal, a step 515 for determining a force, a step 520 for generating resistance, a step 525 for issuing a parking signal, an actuating step 530, a step 535 for engaging a parking brake, an output step 540, and a step 545 for emitting an acoustic signal.

In the step 512 for receiving an actuation signal, an actuation signal is received, wherein according to this exemplary embodiment, the step 510 for issuing the braking signal is executed in response to the step 512 for receiving the actuation signal and the step 505 for inputting the parking position signal, if the speed of the vehicle exceeds the predetermined minimum speed.

In the step 515 for determining a force, a force is determined, with which the gearshift lever is moved by the driver into the intermediate position and/or the gearshift lever parking position. In the step 510 for issuing the braking signal, a force of the braking procedure is then defined on the basis of the force that is applied in response to the step 515 for determining a force according to this exemplary embodiment.

In the step 520 for generating a resistance, a resistance acting on the gearshift lever is generated when the gearshift lever is in the at least one intermediate position and/or the gearshift lever parking position.

In the step 525 for issuing a parking signal, a parking signal for parking the vehicle is issued when the speed of the vehicle is moving at or below the predetermined minimum speed.

In the actuation step 530, at least one electronic parking brake is actuated by the braking signal.

In the step 535 for engaging a parking brake, a parking brake is engaged when the vehicle is moving at a speed of 0 km/h, within a tolerance range.

In the output step 540, a vibration signal is output that causes a vibrating of the gearshift lever when the vehicle is moving at a speed of 0 km/h, and the parking brake in the vehicle is not engaged.

In the step 545 for emitting an acoustic signal, an acoustic signal is emitted that is configured to generate an acoustic sound in response to the engagement of the parking brake.

If an exemplary embodiment comprise an “and/or” conjunction between a first feature and a second feature, this can be read to mean that the exemplary embodiment according to one embodiment contains both the first feature and the second feature, and according to another embodiment, contains either just the first feature or just the second feature.

### REFERENCE SYMBOLS

100 shifting device
105 control unit
110 vehicle
115 gearshift lever
120 gearshift lever unit
125 braking device
130 speed detection device
135 transmission
140 parking position signal
145 braking signal
150 speed signal
155 spring
158 resistance signal
160 parking signal
165 parking brake signal
170 parking brake
300 actuator
400 rotary shifter
500 method for braking a vehicle
505 step for inputting a parking position signal
510 step for issuing a braking signal
512 step for receiving an actuation signal
515 step for determining a force
520 step for generating a resistance
525 step for issuing a parking signal
530 actuation step
535 step for engaging a parking brake
540 output step
545 step for emitting an acoustic signal
D gearshift lever position
N gearshift lever position
P gearshift lever parking position
R gearshift lever position
S gearshift lever position
Z intermediate position

1. A method for braking a vehicle, wherein the method comprises:
inputting a parking position signal that represents a movement of a gearshift lever of an automatic shifting device of the vehicle toward a gearshift lever parking position via at least one intermediate position; and
issuing a braking signal for executing a braking procedure of the vehicle using the parking position signal when a speed signal indicates that a predetermined minimum speed of the vehicle is exceeded.

2. The method according to claim 1, further comprising a step for generating a resistance acting on the gearshift lever when the gearshift lever is in the at least one intermediate position and the gearshift lever parking position.

3. The method according to claim 1, further comprising a step for determining a force with which the gearshift lever is moved by a driver into the at least one of the intermediate position and the gearshift lever parking position.

4. The method according to claim 3, wherein the braking signal defines a braking force for the braking procedure depending on the force that is applied in the step for issuing the braking signal.

5. The method according to claim 1, further comprising a step for issuing a parking signal for parking a vehicle when the speed signal indicates that the speed of the vehicle is at or below the predetermined minimum speed.

6. The method according to claim 1, further comprising an actuation step for actuating at least one electronic parking brake using the braking signal.

7. The method according to claim 1, further comprising a step for outputting a vibration signal to cause a vibrating of the gearshift lever when the speed signal indicates that the vehicle is moving at a speed of 0 km/h and the parking brake in the vehicle is not engaged.

8. The method according to claim 1, further comprising a step for engaging a parking brake when the speed signal indicates that the vehicle is moving at a speed of 0 km/h within a tolerance range.

9. The method according to claim 8, further comprising a step for emitting an acoustic signal that is configured to generate an acoustic sound in response to the engagement of the parking brake.

10. The method according to claim 1, further comprising a step for receiving an actuation signal, wherein the step for issuing the braking signal is carried out in response to receiving the actuation signal and inputting the parking position signal when the speed signal indicates that the speed of the vehicle exceeds the predetermined minimum speed.

11. The method according to claim 1, wherein, in the input step for the parking position signal, the parking position signal is input, and wherein the movement of the gearshift lever is executed by rotation of the gearshift lever.

12-15. (canceled)

16. A shifting device for a vehicle, comprising:
a gearshift lever; and
a control unit,
wherein a movement of a gearshift lever of an automatic shifting device of the vehicle toward a gearshift lever parking position via at least one intermediate position inputs a parking position signal to the control unit, and
wherein the control unit issues a braking signal for executing a braking procedure of the vehicle using the parking position signal when a speed signal indicates that a predetermined minimum speed of the vehicle is exceeded.

17. The shifting device of claim 16, wherein a resistance acts on the gearshift lever when the gearshift lever is in the at least one intermediate position and the gearshift lever parking position.

18. The shifting device of claim 16, wherein the control unit determines a force with which the gearshift lever is moved by a driver into the at least one of the intermediate position and the gearshift lever parking position.

19. The shifting device of claim 18, wherein the braking signal defines a braking force for the braking procedure depending on the force that is applied in the step for issuing the braking signal.

20. The shifting device of claim 16, wherein the control unit issue a parking signal for parking a vehicle when the speed signal indicates that the speed of the vehicle is at or below the predetermined minimum speed.

21. The shifting device of claim 16, wherein the control unit is configured to cause actuation of at least one electronic parking brake using the braking signal.

22. The shifting device of claim 16, wherein the control unit is configured for outputting a vibration signal to cause a vibrating of the gearshift lever when the speed signal indicates that the vehicle is moving at a speed of 0 km/h and the parking brake in the vehicle is not engaged.

23. The shifting device of claim 16, wherein the control unit is configured to cause actuation of a parking brake when the speed signal indicates that the vehicle is moving at a speed of 0 km/h within a tolerance range.

24. The shifting device of claim 23, wherein the control unit is configured to cause emission of an acoustic signal that is configured to generate an acoustic sound in response to the engagement of the parking brake.
